(19) United States
(12) Patent Application Publication
(10) Pub. No.: US 2019/0303861 A1
(43) Pub. Date: Oct. 3, 2019

(54) SYSTEM AND METHOD FOR ITEM RECOVERY BY ROBOTIC VEHICLE

(71) Applicant: QUALCOMM Incorporated, San Diego, CA (US)

(72) Inventors: Dylan Scott MATHIAS, San Diego, CA (US); Michael Franco TAVEIRA, Ranch Santa Fe, CA (US); Charles Paul MATHIAS, Sebastopol, CA (US); Damir DIDJUSTO, San Diego, CA (US)

(21) Appl. No.: 16/007,072

(22) Filed: Jun. 13, 2018

Related U.S. Application Data
(63) Continuation of application No. 15/939,605, filed on Mar. 29, 2018.

(51) Int. Cl. G06Q 10/08; B64C 39/02; G06Q 30/00

(52) U.S. Cl. CPC G06Q 10/0837; B64C 39/024; G06Q 30/01; B64C 2201/128

(57) ABSTRACT

Various embodiments enable recovery with a robotic vehicle of an item placed by a user in a delivery area. The presence of the item in the delivery area may be determined using images captured by a camera, with descriptive recovery parameters derived and included in a recovery request. Recovery parameters may also include information stored in a user account and information input by a user using an application executing on a user device. The delivery area and application may be associated with the user account. The recovery request may be sent to a remote server which dispatches a robotic vehicle to the delivery area to recover the item and routes the robotic vehicle with the recovered item to a location based on information in the user account. A selection of robotic vehicle type may be based on the item's weight or one or more of its physical dimensions.

### RELATED APPLICATIONS

This application is a continuation of U.S. Non-provisional patent application Ser. No. 15/939,605, filed Mar. 29, 2018, for “SYSTEM AND METHOD FOR ITEM RECOVERY BY ROBOTIC VEHICLE” and claims the benefit thereof, the entirety of which is incorporated herein by reference.

### BACKGROUND

A customer may find it necessary to return previously delivered item to its originating source, such as a vendor merchandizing the item or another destination. Conventionally, the customer may be required to arrange for return transportation, for example, by first communicating with the vendor to obtain a return authorization, and then either arranging for pickup of the item for return by a delivery service or transporting the item to a facility from which the item may be subsequently transported to the vendor's receiving facility or some other destination. In the event of frequent item deliveries by robotic vehicles, and in view of the convenience of automated deliveries to the customer, there is a need in the market for a system and method for conveniently returning items when required similarly to that of the delivery.

### SUMMARY

Various embodiments include methods of returning an item by placing the item in a delivery area for retrieval by a robotic vehicle (RV).

Embodiments may include associating a user account with a camera in the delivery area, capturing one or more images of the delivery area, determining that a placement of the item has occurred in the delivery area by use of the images, and activating a recovery request for an RV, the recovery request based at least in part on information associated with the user account.

Some embodiments include determining that a placement of the item has occurred in the delivery area using one or more of the cameras, and/or determining the placement of the item using a remote server in communication with one or more of the cameras.

Embodiments may further include controlling the RV to travel to the delivery area and to obtain the item and routing the RV with the obtained item to a location based on the information associated with the user account.

In various embodiments, capturing the one or more images of the delivery area is triggered using an application executed on a user device, the application associated with the user account. Activating the recovery request may also include sending the recovery request using the application to a server configured to dispatch the RV to respond to the recovery request, where the RV is selected at the server based at least on one of the weight or the one or more physical dimensions of the item.

Embodiments may include determining that the item is the same as a previously delivered item by comparing one or more physical dimensions of the item with one or more physical dimensions of a previously delivered item. That the item is the same as a previously delivered item may be determined in other embodiments by comparing one or more visual markers of the item with one or more visual markers of the previously delivered item.

Further embodiments include a system and a processor configured to execute operations of the methods summarized above. Further embodiments include means for performing functions of the methods summarized above. Further embodiments include a non-transitory processor-readable storage medium having stored thereon processor-executable instructions configured to cause a processor to perform operations of the methods summarized above.

### BRIEF DESCRIPTION OF THE DRAWINGS

The accompanying drawings incorporated herein and constituting part of this specification illustrate exemplary embodiments. Together with the general description given above and the detailed description given below, the drawings serve to further explain the features of the claims.

FIGS. 1A-D illustrate an example system using a delivery pad for recovery of an item and delivery to a return delivery destination.

FIGS. 1E-H illustrate an example system using one or more cameras for recovery of an item and delivery to a return delivery destination.

FIG. 2A is a functional block diagram of a delivery pad-based system for item recovery.

FIG. 2B is a functional block diagram of an example processing module.

FIG. 2C is a diagram of an example delivery pad surface including a grid of weight sensor nodes.

FIG. 3 is a functional block diagram of a camera-based system for item recovery.

FIG. 4A is a flowchart for an example method of item recovery using a delivery pad.

FIG. 4B is a flowchart for an example method of sensing a placement of an object on a delivery pad surface and confirming it as an item for retrieval and return by an RV.

FIG. 5A is a flowchart for an example method of item recovery using a camera device.

FIG. 5B is a flowchart for an example method of determining whether an object placed in a delivery area 146 is an item for return.

FIG. 6A is a flowchart for an example method of processing recovery request at a remote server.

FIG. 6B is a flowchart for an example method of processing a recovery request at an RV.

FIG. 6C is a flowchart for an example method of processing image data at a remote server.

FIGS. 7A-E are flowcharts for example methods of directing manual and semi-automatic item recovery with a user device executing an application.

FIG. 8 illustrates an example server device.

### DETAILED DESCRIPTION

Various embodiments will be described in detail with reference to the accompanying drawings. Wherever possible, the same reference numbers will be used throughout the drawings to refer to the same or like parts. References made to various examples and implementations are for illustrative purposes and are not intended to limit the scope of the claims.

Embodiments include methods and systems for recovering an item to a return delivery destination using a robotic vehicle (RV). A notification of a placement of a return item (also referred to variously herein as an “item for recovery,” or simply an “item”), on the surface of a delivery pad or in a delivery area may be received by a processing module which associates the item with a user account and user. It will be understood that as used herein, the terms “delivery pad” and “delivery area” are generalized terms describing locations where an item may be either delivered or retrieved. A recovery request may then be generated that identifies the item to be recovered and may include inter alia various physical descriptors of the item, a delivery location, and the return delivery destination for the return item. The recovery request may be sent to a remote server that may select a most appropriate RV for retrieving the item and dispatch the selected RV to the location of the delivery pad or delivery area to retrieve the item. Embodiments provide for generating and sending a recovery request using an application on a computing device. In these and other embodiments, retrieval of a return item may therefore be accomplished by placing the item on the delivery pad or in the delivery area.

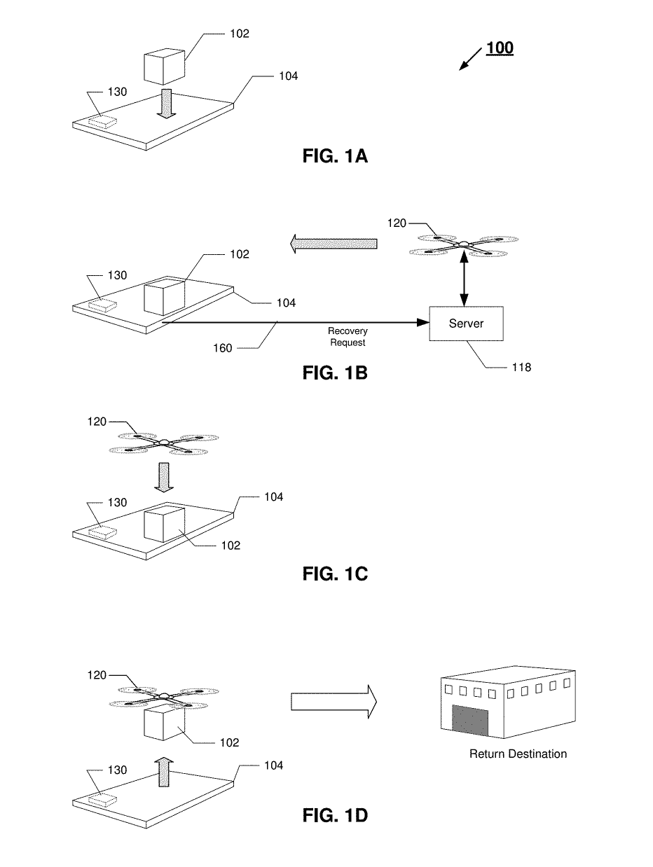

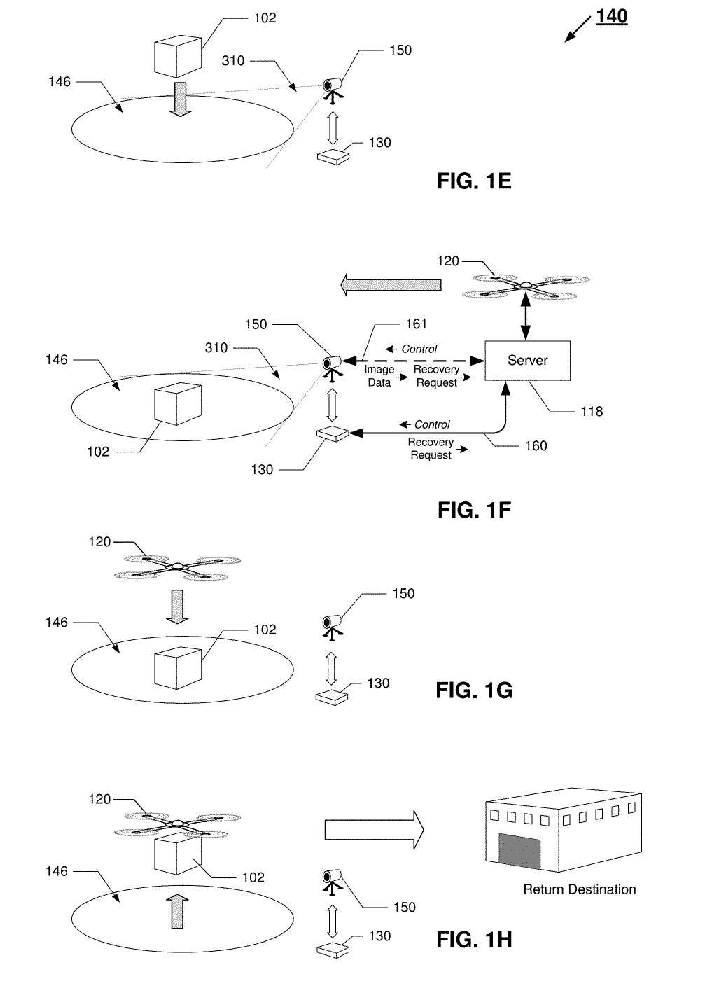

The term “robotic vehicle” (or “RV”) as used herein refers to one of various types of autonomous vehicles (e.g., autonomous aircraft, land vehicles, waterborne vehicles, or a combination thereof) that may not utilize onboard human operators. An RV may include an onboard computing device configured to operate the RV without remote operating instructions (i.e., autonomously), such as those from a human operator or remote computing device. Alternatively, the onboard computing device may be configured to operate the RV with remote operating instructions or updates to instructions stored in a memory of the onboard computing device. The RV may be propelled for movement in a variety of ways. For example, a plurality of propulsion units, each including one or more propellers or jets, may provide propulsion and/or lifting forces for an airborne RV and any payload (e.g., item(s) for delivery) carried by the RV for transport. Additionally, or alternatively, the RV may include inter alia wheels, caterpillar treads, floatation devices, or other non-aerial movement mechanisms enabling movement on the ground, across water, or under water. Although RV 120 depicted in FIGS. 1B-D, 1F-H, 2A, and 3 is an aerial RV, embodiments disclosed herein are not limited to aerial vehicles and are contemplated for implementation using any type of RV. Embodiments described with reference to an RV, particularly an unmanned aerial RV, are done so for generality and ease of reference. However, the description of any particular RV is not intended to limit the scope of the claims to unmanned aerial RVs. Further, the RV may be powered by one or more types of power source, such as electrical, chemical, electro-chemical, or other power reserve, which may power the propulsion units, the onboard computing device, and/or any other onboard components.

As used herein, the term “recovery request” refers to an electronic request or agreement placed for at least one item, including sufficient details to arrange for recovery (or “retrieval,” as used herein) of the at least one item. An item includes any good, merchandise, product, material, and other individual thing that may be delivered and/or transported by an RV. A recovery request may include user account information, item identification, a transaction description, information regarding quantities purchased and/or specified for recovery, unit prices, item origin and recovery locations, requested lead time for recovery, any terms of agreement, and various recovery parameters.

As used herein, “recovery parameters” refer to information pertaining to and included by a recovery request, comprising item(s) to be retrieved or transported, a destination for the item(s) after retrieval, etc. Recovery parameters may include information obtained directly and indirectly from a previous delivery order, such as that associated with a previous delivery to a user or location of the item to be recovered according to methods and systems described herein. Recovery parameters may include information regarding when and/or where the recovery request was placed, when recovery of the item is expected, when recovery of the item is guaranteed, one or more destinations for return delivery (“return destinations”) of the item after retrieval, travel routes for the retrieval and return delivery, current weather conditions, predicted weather conditions, travel time, perishability of the item (e.g., measures of resistance to elements, including temperature), required item protection(s), type(s) of packaging, monetary value of the item, cost to recover the item, sizes, dimensions, weights, material/structural properties, and contextual information that may affect retrieval of the item identified in the recovery request. It will be understood that the term “return item” as used herein will typically include any packaging materials enclosing an object for delivery or recovery. The cost to retrieve the return item may comprehend an opportunity cost of recovering the item presently versus waiting instead, for example, for a future delivery of another item that may place an RV in position after the delivery to efficiently retrieve the return item. In addition, recovery parameters may include, but are not limited to, mission information identifying multiple actual and potential return destinations, routes to each return destination, map or travel directions, directions of travel, in what mode the RV should travel (e.g., air, land, and/or sea), chances of success and/or failure for retrieval of the item, timing information relating to each return destination, and the like. In addition, recovery parameters may include route details, distance, travel speed(s), flight restrictions along a route, obstacles, permissions, or other information that may be useful for traveling, landing, fueling, recharging, and assisting the RV in reaching the recovery site or return destination(s). Recovery parameters may further include information regarding, for example, hazards to avoid, how recovery should be executed (e.g., raising from a height, land and wait, land and recover, etc.), and/or proper recovery verification information. Proper recovery verification information may include security information and/or enable recognition of a retrieval location or other visual recognition information (e.g., item recognition).

The term “recovery order” will be used herein to describe messaging comprising recovery parameters and/or user account data that is sent to an RV to engage it for an operation to retrieve a related return item.

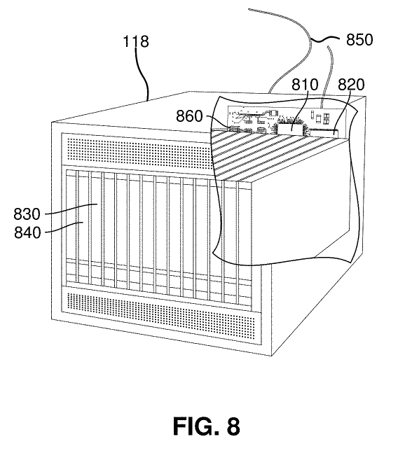

The term “computing device” is used herein to refer to an electronic device equipped with at least one processor. Examples of computing devices may include recovery pad management computers, mobile devices (e.g., cellular telephones, wearable devices, smartphones, smartwatches, web-pads, tablet computers, Internet-enabled cellular telephones, Wi-Fi®-enabled electronic devices, personal data assistants (PDAs), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.). Examples of computing devices suitable for use with various embodiments are described with reference to FIG. 8.

The term “server” as used herein may refer to any computing device capable of functioning as a server, such as a master exchange server, web server, and a personal or mobile computing device configured with software to execute server functions. Thus, various computing devices may function as a server, such as one, or all, of cellular telephones, smart-phones, web-pads, tablet computers, Internet enabled cellular telephones, Wi-Fi® enabled electronic devices, laptop computers, personal computers, and similar electronic devices equipped with at least a processor, memory, and configured to receive electronic orders and communicate with an RV. A server may be a dedicated computing device or a computing device including a server module (e.g., running an application that may cause the computing device to operate as a server). A server module (or server application) may be a full function server module, or a light or secondary server module (e.g., light or secondary server application). A light server or secondary server may be a slimmed-down version of server type functionality that may be implemented on a personal or mobile computing device, thereby enabling the light or secondary server to function as an Internet server (e.g., an enterprise e-mail server) to a limited extent, such as what may be necessary to provide various functionalities described herein. A “remote server” as used herein may be physically situated apart from a user device, and communicatively coupled to the user device using cellular, WAN, LAN, and satellite-based means. Examples of servers suitable for use with various embodiments are described with reference to FIG. 8.

As used herein, a “user account” may include information such as, but not limited to, the location of an associated delivery pad or delivery area, a history of previously delivered items, the history including attributes of the packages such as, but not limited to, physical dimensions, colors, labeling (e.g., visual markers including serial numbers, serial bars, QR codes, etc.), and weights. A user account may be associated with a delivery pad or delivery area during a configuration phase of the delivery pad or delivery area. The user account may be maintained at a remote server, for example, and accessed over a communication link by a delivery pad, a camera, a user device, an RV, or any other component or device related to an item recovery system as described herein.

Embodiments include systems and methods combining a delivery pad or delivery area, a processing module, a camera, and an RV together as an item recovery system. Configurations of one or any of a delivery pad or delivery area, processing module, and RV may be based on recovery parameters (described above) in either or both a user account and a recovery request. RV components (e.g., parts, accessories, enhancements, complements, etc.) may be configured based on recovery parameters and suitability for handling an item in accordance with item-specific requirements. Further, an RV configuration may be set or updated before departure for a recovery mission and/or during the recovery mission itself. Various embodiments comprehend RVs and RV components that are configurable and adaptable to a variety of mission requirements, as well as RVs adhering to standardized requirements, but which are not configurable and adaptable.

FIGS. 1A-D depict a functional overview of a system 100 for returning an item to a vendor or other recipient. In FIG. 1A, an item 102 is placed on a delivery pad 104, where the delivery pad 104 has been associated with a user account, the user account including information regarding a user returning the item such that the item is automatically associated with the user. The delivery pad 104 may also be functionally coupled to a processing module 130, depicted in FIGS. 1A-D as disposed internally to the delivery pad 104. An external disposition of a control module 130 is also contemplated in embodiments described herein.

In FIG. 1B, the placement of the item 102 on the delivery pad 104 is sensed. In an embodiment, the processing module 130 is configured to analyze weight, shape, and dimensional measurements from the delivery pad 104 to determine that an item 104 has been placed. Embodiments described herein provide that other sensor data and user input data may be included for determining at the processing module 130 whether an item 102 for recovery has been placed on the delivery pad 104. Once it is determined that an item 102 has been placed on the delivery pad 104, the processing module 130 may send a recovery request including recovery parameters over a communications link 160, the communications link 160 including wired and wireless links, to a remote server 118. The remote server 118 may receive the recovery request and dispatch an RV 120 to recover the item 102 at the delivery pad 104. Once dispatched, the RV 120 travels to the location of the delivery pad 104, wherein routing the RV 120 may be based on information associated at least with the user account.

In FIG. 1C, the RV 120 arrives at the delivery pad 104 and engages an appropriate retrieval procedure, and in FIG. 1D the RV 120 transports the item 102 to a return destination, e.g., to a vendor or other recipient. Embodiments contemplate controlling the RV 120 using resources of any or all, alone, partially, or in any combination, the delivery pad 104, remote server 118, and RV 120, with routing based at least on information in the user account 112.

FIGS. 1E-H depict a functional overview of another system 140 for returning an item to a vendor or some other recipient. In FIG. 1E, an item 102 is placed in a delivery area 146, which lies in the field(s) of view (FOV) of one or more cameras 150. The delivery area 146 may be associated via a camera 150 with a user account, the user account including information regarding a person returning the item such that the item is automatically associated with the person. In an embodiment, the cameras are functionally coupled to a processing module 130 configured to receive and analyze image data from the cameras. Embodiments described herein contemplate a processing module 130 externally disposed from a camera 150 and communicatively coupled by wired and/or wireless connection or disposed internally to the camera 150.

In FIG. 1F, the placement of the item 102 in the delivery area 146 is sensed. In an embodiment, the processing module 130 is configured to analyze image data from the camera(s) 150 to determine that an item 104 has been placed. The camera(s) 140 capture images of the item 102 as it is placed in the delivery area 146 and send the resulting image data to the processing module 130. The processing module 130 may analyze the image data and determine whether the item 102 has been placed in the delivery area 146 for recovery. The analysis may include capture, registration, and decoding of various visual markers such as serial numbers, serial bars, QR codes and the like, with information derived from which being included in recovery parameters and/or stored with a user account 112. In an embodiment, the processing module 130 may forward the image data to a remote server 118 which may analyze the image data as described. Embodiments described herein also provide that user input data may be included for determining at the processing module 130 or the remote server 118 whether an item 102 for recovery has been placed in the delivery area 146. Once it is determined that an item 102 has been placed on the delivery area 146, the processing module 130 may send a recovery request including recovery parameters over a communications link 160, the communications link 160 including wired and wireless links, to a remote server 118. In an embodiment, the camera 150 may send the recovery request including recovery parameters over a communications link 161, the communications link 161 including wired and wireless links, to a remote server 118. The remote server 118 may receive the recovery request and dispatch an RV 120 to recover the item 102. Where the remote server 118 has performed the analysis on image data forwarded by the processing module 130, it may itself generate a recovery request and dispatch the RV 120 to recover the item 102.

In other embodiments, the camera(s) 150 may capture images of the item 102 as it is placed in the delivery area 146 and send the resulting image data to the remote server 118. The remote server 118 may analyze the image data and determine whether the item 102 has been placed in the delivery area 146 for recovery. The analysis may include capture, registration, and decoding of various visual markers such as serial numbers, serial bars, QR codes and the like, with information derived from which being included in recovery parameters and/or stored with a user account 112. Embodiments described herein provide that user input data may be included for determining at the remote server 118 whether an item 102 for recovery has been placed in the delivery area 146. Once it is determined that an item 102 has been placed on the delivery area 146, the remote server 118 may generate a recovery request and dispatch a most appropriate RV 120 to recover the item 102. Once dispatched, the RV 120 travels to the location of the delivery area 146, wherein routing the RV 120 may be based on information associated at least with the user account.

In FIG. 1G, the RV 120 arrives at the delivery area 146 and engages an appropriate retrieval procedure, and in FIG. 1H the RV 120 transports the item 102 to a return destination, e.g., to a vendor or other recipient. Embodiments contemplate controlling the RV 120 using resources of any or all, alone, partially, or in any combination, the delivery pad 104, remote server 118, and RV 120, with routing based at least on information in the user account 112.

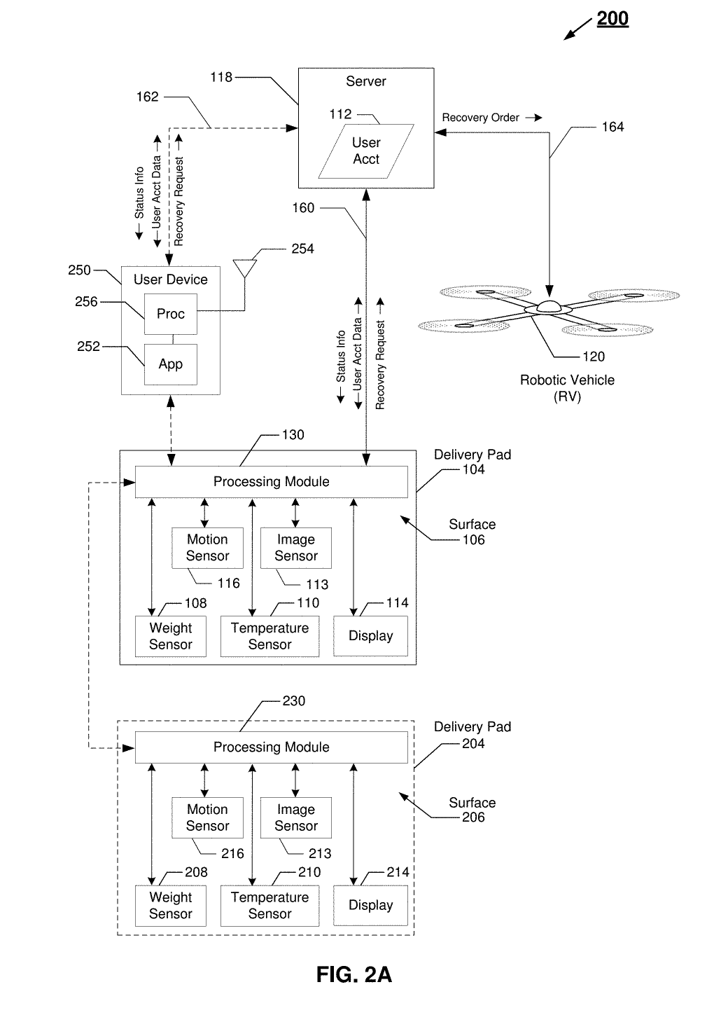

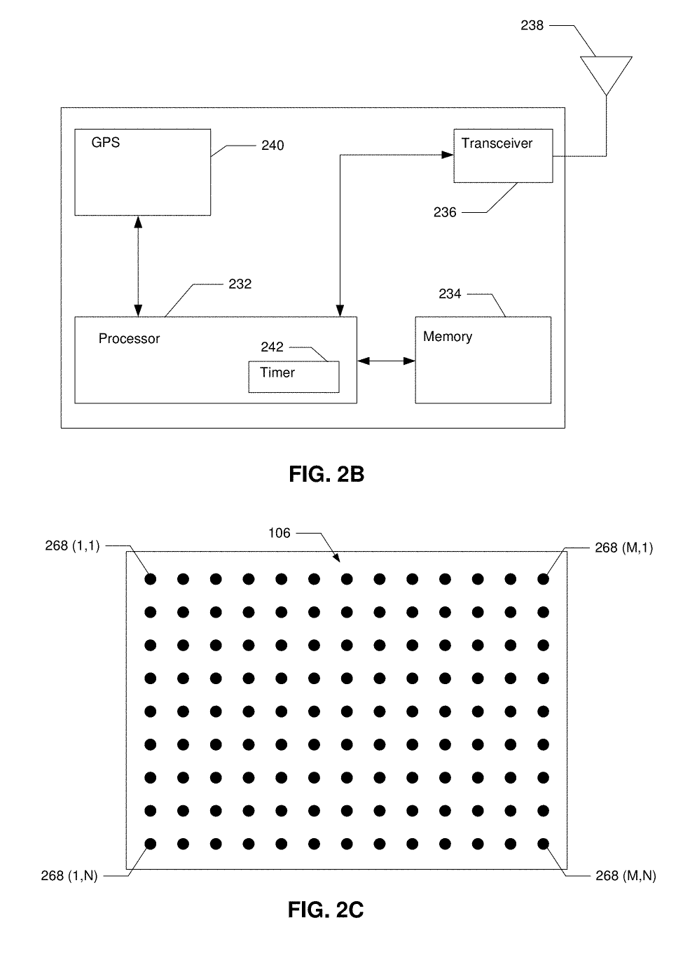

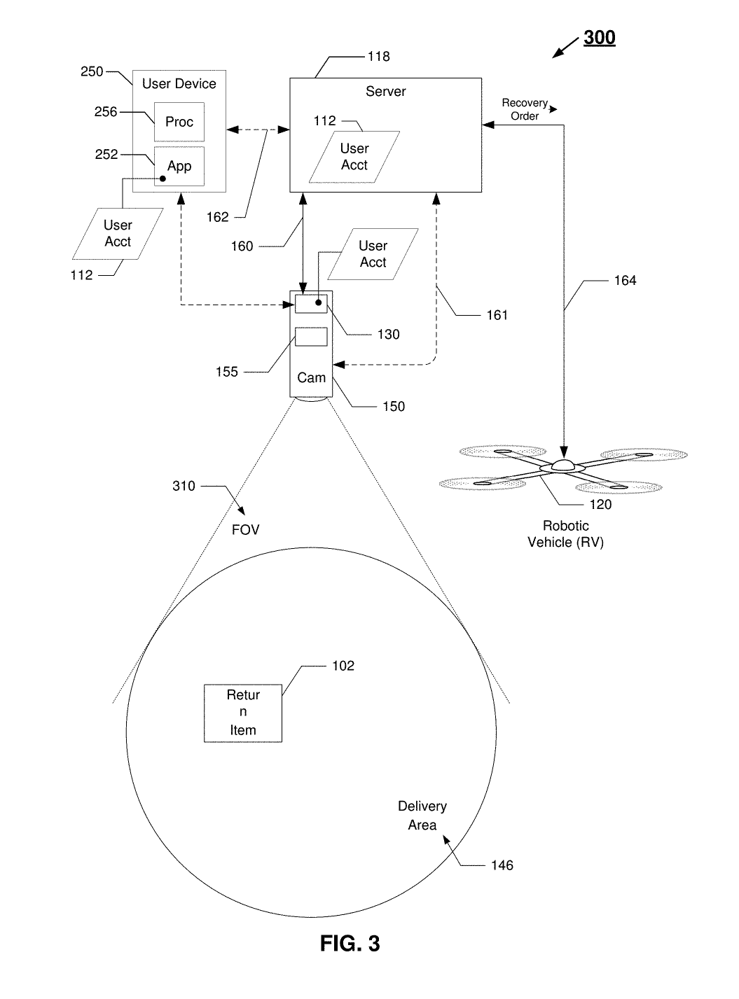

FIG. 2A is a functional block diagram depicting an example pad-based delivery system and apparatus 200 for item recovery. As described above, a delivery pad 104 is associated with a user account 112, which may include information such as the location of the delivery pad 104, a history of previously delivered items including attributes of the packages such as, but not limited to, physical dimensions, colors, labeling, and weights. A user account 112 may be associated with a delivery pad 104 during a configuration phase of the delivery pad 104. The user account 112 may be maintained on a remote server 118, for example, and accessed by the delivery pad 104 over a communication link 160 and/or by a user device 250 over a communication link 162. In some embodiments, the user account 112 may be maintained by a processing module 130 or processor 256 on the user device 250. A delivery pad 104 comprises a delivery pad surface 106 upon which an item 102 may be placed when it is desired to return the item 102 to a return destination, such as a vendor from which the item 102 was originally purchased. A weight sensor 108 and temperature sensor 110 may be functionally coupled to the delivery pad surface 106. In embodiments, the weight sensor 108 is used to sense the placement of an item 102 on the delivery pad surface 106, resulting in an activation of a recovery request. The weight sensor 108 may be used to measure the weight of the item 102. The temperature sensor 110 may be used to recognize a false item placement such as, for example, when a pet might lie on the delivery pad surface 106 and a rise in temperature due to its body heat is sensed. A measured temperature at the delivery pad 104 may also inform performance (e.g., flight) predictions at the site of the delivery pad 104 of the RV 120 dispatched to recover the item 102. It will be understood that other circumstances exist under which a temperature measurement may support the process of recovering item 102 for return. An image sensor 113 (e.g., a fisheye camera) and/or motion sensor 116 may be included and used for determining whether a weight sensed on the delivery pad surface 106 is animate and/or for detecting motions nearby the delivery pad 104 which, when detected, may cause various processes to trigger (e.g., starting a video recording, sounding an alarm, sending a notification, etc.). It will be appreciated that the image sensor 113 and/or motion sensor 116 may be disposed internally or externally to the delivery pad 104. Through a communications link 160, or by communications link 162 via user device 250, a delivery pad 104 may transmit recovery requests and user account data to a remote server 118, and receive recovery information, including status updates, and user account data from the remote server 118. In various embodiments, the user account 112 that is associated with the delivery pad 104 during its configuration is then automatically associated with the item 102 when it is placed on the delivery pad surface 106, with various information in the user account 112 included in a resulting recovery request. A display 114 may also be included with a delivery pad 104 to annunciate status information generated at the delivery pad 104, the application 252, or remote server 118. Status information may include, but not be limited to, indications of success or failure regarding any aspect of a recovery operation for an item 102.

Depicted in FIG. 2A is a user device 250 including a processor 256 with which an application 252 may be executed. A user device 250 may be any device including personal computers, laptop computers, and mobile computing devices (e.g., smartphones, pads, tablets, smartwatches, etc.). Though not shown, it is expected that a user device 250 will include a user interface for information display and manual input. In various embodiments, the application 252 may be used to configure the delivery pad 104, including associating itself with a user account 112, and the user account 112 with the delivery pad 104. The user account 112 may be exclusively maintained by the application 252 or may be maintained on a remote server 118 and mirrored by the application 252. Embodiments also provide for a user using the application 252 manually activate a recovery request. Accordingly, the user may place an item 102 on the delivery pad surface 106 and with the application activate a recovery request and send it to a remote server 118, the recovery request including recovery parameters derived from measurements from sensors on the delivery pad 104. When activated manually at the application 252, depending upon system configuration the recovery request may be sent to the remote server 118 from the user device 250 or from the delivery pad 104. After receiving the recovery request at the server 118, the server 118 may process the recovery parameters and data from the user account 112 and generate a recovery order, which may be sent on a communication link 164 to an RV 120. Embodiments contemplate controlling the RV 120 using resources of any or all, alone, partially, or in any combination, the delivery pad 104, processing module 130, user device 250, processor 256, application 252, remote server 118, and RV 120, with routing based on information in the user account 112.

A user device 250 may include a processor 256 coupled with a touch screen controller, radio communication elements, speakers and microphones, and an internal memory. The processor 256 may be one or more multi-core integrated circuits designated for general or specific processing tasks. An internal memory may be volatile or non-volatile, secure and/or encrypted or unsecure and/or unencrypted, or any combination thereof. In an embodiment (not shown), the user device 250 may also be coupled to an external memory, such as an external hard drive.

The user device 250 may also have one or more radio signal transceivers (e.g., Peanut, Bluetooth, Bluetooth LE, ZigBee, Wi-Fi®, NFC, radio frequency (RF) radio, RFID, etc.) and an antenna 254 for sending and receiving communications, coupled to the processor 256. The radio signal transceivers and the user device antenna 254 may be used with the circuitry mentioned above to implement various wireless transmission protocol stacks and interfaces. The user device 250 may further include a cellular network wireless modem chip coupled to the processor that enables communication via a cellular network.

A delivery pad 104 may include a processing module 130. As depicted in FIG. 2A, a processing module 130 may be disposed internally within the delivery pad 104, though embodiments described herein also comprehend a processing module 130 disposed externally to the delivery pad 104. FIG. 2B is a functional block diagram of an example processing module 130. A processing module 130 may include components such as at least one processor 232, a memory 234, a transceiver 236, a GPS module 240, and a timer function 242, which may be integrated together in a single device, chip circuit board or system-on-chip. In various embodiments, the processing module 130 performs analytical tasks related to determining whether an item 104 has been placed on the delivery pad surface 106. Using measurements from the weight sensor 108, the processor 232 may perform a comparison of a measured weight at the weight sensor 108 to a weight threshold; if the measured weight is greater than the weight threshold, a determination may be made that an item 102 has been placed on the delivery pad surface 106. A memory 234 may be used to store various data including, but not limited to, recovery parameters, various data related to a user account 112, and measurement data from various sensors such as the weight sensor 108, temperature sensor 110, and any others that may be functionally coupled to the delivery pad 104. A timer 242 may be used for establishing an elapsed time since a weight is sensed on the delivery pad surface 106. In embodiments, if the elapsed time is greater than a predetermined threshold, then a weight sensed on the delivery pad surface 106 may be assumed to be an item 102 placed there for return, triggering a recovery request. Similarly, if the timer 242 is started when a delivery is made (e.g., an item for delivery is placed on the delivery pad 104 by an RV 120) and the sensed weight at the time of delivery has not changed and/or has been sensed continuously by the time a threshold is reached, then it may be assumed that the delivered item should be retrieved, triggering a recovery request. A transceiver 236 with an antenna 238 may perform operations including either, or both, transmitting and receiving data related to the recovery of the item 102. In an example, the transceiver 236 may transmit a recovery request over the communication link 160 to the remote server 118 and may receive user account 112 update information from the server. In an embodiment, the transceiver 236 may be configured to transmit sensor data from the weight sensor 108 and/or the temperature sensor 110 (or any other sensor disposed at the delivery pad 104), and/or processing results generated by the processing module 130. The sensor data, with partial or full processing results, may be sent to the remote server 118 for further analysis to confirm that an item 102 placed on the delivery pad 104 is appropriately identified for retrieval. The transceiver 236 may also be configured according to various embodiments for RFID operations, for example to read an RFID tag on an item 102 for various recovery parameters. The transceiver 236 may also be used to receive data from a user device 250 including, but not limited to, manual activation commands, data related to the user account 112, messaging acknowledgements, etc. Multiple antennas 238 may be included to handle various radio frequency (RF) based tasks, including signaling that may be required for operation of the GPS 240, and as a beacon for RV 120 navigation to and from the delivery pad 104 (or delivery area 146, disclosed herein).

FIG. 2A also depicts a second delivery pad 204, which may optionally function in conjunction with the delivery pad 104. The second delivery pad 204 includes components mirroring those of the delivery pad 104: a processing module 230, weight sensor 208, temperature sensor 210, display 214, timer 216, and motion sensor 216. In an embodiment, the second delivery pad 204 may act in parallel by functioning as a second instance of the delivery pad 104. In other embodiments, the second delivery pad 204 may function mainly, for example, as a platform for accepting incoming deliveries by RV 118 while the delivery pad 104 functions as a platform for handling outgoing transfers of an item 102 to a return destination such as an originating source or vendor. It will be understood, however, that distinguishing two delivery pads 104, 204 is for purposes of example since either delivery pad 104, 204 may function as an incoming or outgoing delivery pad. In an embodiment, when both the delivery pad 104 and second delivery pad 204 have no objects on them, and an item 102 is placed only on the surface of the delivery pad 104, a first weight measurement may be taken by the weight sensor 108. A second weight measurement may then be taken at the second weight sensor 208. A non-zero second weight measurement may then be subtracted from the first weight measurement on the inference that whatever is causing the non-zero second weight measurement is likewise adding to the first weight measurement. For example, snow may have accumulated on both the delivery pad surface 106 and the second delivery pad surface 206, introducing a bias weight on both delivery pads 106, 206. Subtracting the bias weight, i.e., the second weight measurement, from the first weight measurement therefore yields a more accurate measure of the item 102 on the delivery pad surface 106.

FIG. 2C is a diagram of a delivery pad surface 106 with an M×N grid of weight sensor nodes 268 disposed on it instead of a weight sensor 108. In addition to sensing the weight of an item 102 placed upon the delivery pad surface 106, a shape of the bottom of the item 102 may be estimated at the processing module 130 by noting which of the M×N weight sensor nodes 268 are loaded. In this way, one or more physical dimensions of the item 102 may be derived and compared with, in an example, item dimensions stored as part of a delivery history in the memory 234 and/or on the user device 250 by the application 252. Estimated dimensions of an item 102 that are substantially the same as corresponding dimensions of a previously delivered item may therefore inform a confirmation that the two items are the same.

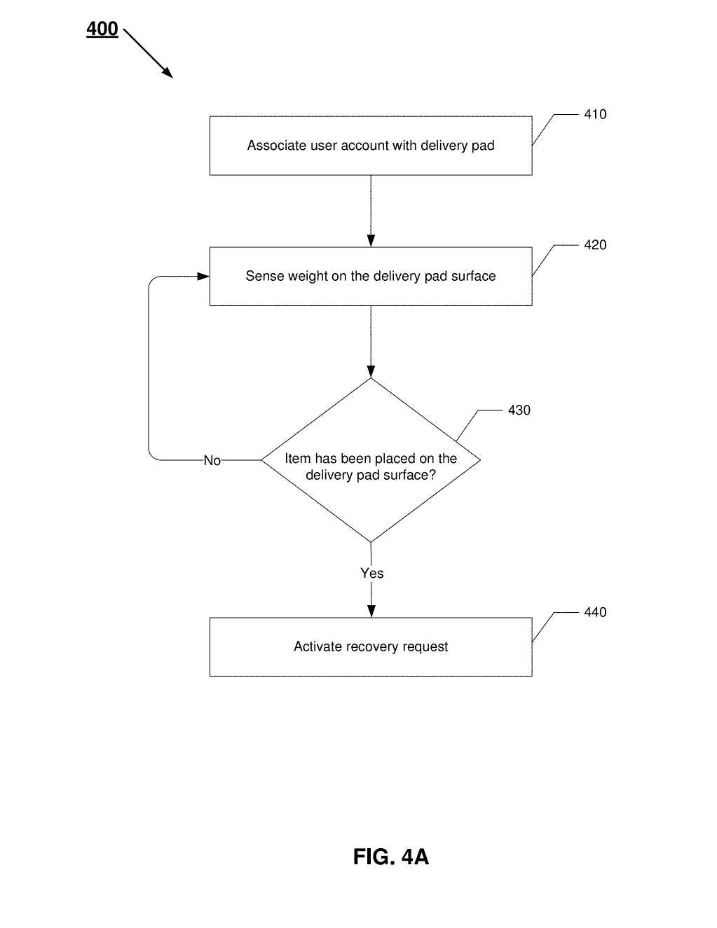

FIG. 3 is a functional block diagram depicting an example camera-based delivery system and apparatus 300 for item recovery. It will be understood that embodiments of camera-based methods and systems disclosed herein contemplate the use of one or more cameras capable of multiple image capture and/or video capture in variable lighting conditions. As described above, a delivery area 146 lies in and corresponds with the field(s) of view (FOV) 310 of one or more cameras 150. The delivery area 146 may be associated with a user account 112 including information such as a location of the delivery area 146 and a history of previously delivered items. The history may include attributes of related packaging such as, but not limited to, physical dimensions, colors, labeling, and weights. Embodiments include associating the user account 112 with the delivery area 146 during a configuration phase using the camera(s) 150 and/or an application 252 hosted on a user device 250 communicatively coupled with at least one camera 150. The application 252 may associate itself with the user account 112, associate the user account 112 with delivery area 146, and associate the user account 112 with the camera 150 and/or control module 130. The user account 112 associated with the delivery pad 104 may then be automatically associated with an item 102 when it is placed in the delivery area 146, with various information in the user account 112 included in a resulting recovery request. The user account 112 may be maintained on a remote server 118, for example, and accessed by a control module 130 over a communication link 160, a camera 150 over a communication link 161 and/or a user device 250 over a communication link 162, or maintained by the application 252, or by the processing module 130 onboard or offboard a camera 150. A delivery area 146 may comprise a physical space in which an item 102 may be placed when it is desired to return the item 102 to a return destination. Through the communications link 160, 161, 162, the control module 130, camera 150 or application 252 on a user device 250 may transmit recovery requests and user account data to a remote server 118 and receive recovery information and user account data and updates from the remote server 118. After receiving the recovery request at the server 118, the server 118 may process the recovery parameters, and data from the user account 112, and generate a recovery order, which may be sent on a communication link 164 to an RV 120. A camera 150 may include an interface 155 enabling user input and information display as well as a processing module 130 comprising components for local processing and communication capabilities as depicted in FIG. 2B. Embodiments provide for processing and communication components (e.g., processor 232, memory 234, transceiver 236, antenna 238, and/or GPS module 240) built into the camera 150 individually, or in sub-combinations, functioning together as a processing module 130 as described herein. In an embodiment, a processing module 130 may perform all or part of the machine vision processing described here. In other embodiments, the camera 150 may offload some or all local processing to an application 252 or send captured images to the server 118 for processing and to execute remaining steps for recovery of an item 102 from the delivery area 146. Embodiments contemplate controlling the RV 120 using resources of any or all, alone, partially, or in any combination, a camera 150, processing module 130, user device 250, processor 256, application 252, remote server 118, and RV 120, with routing based on information in the user account 112.

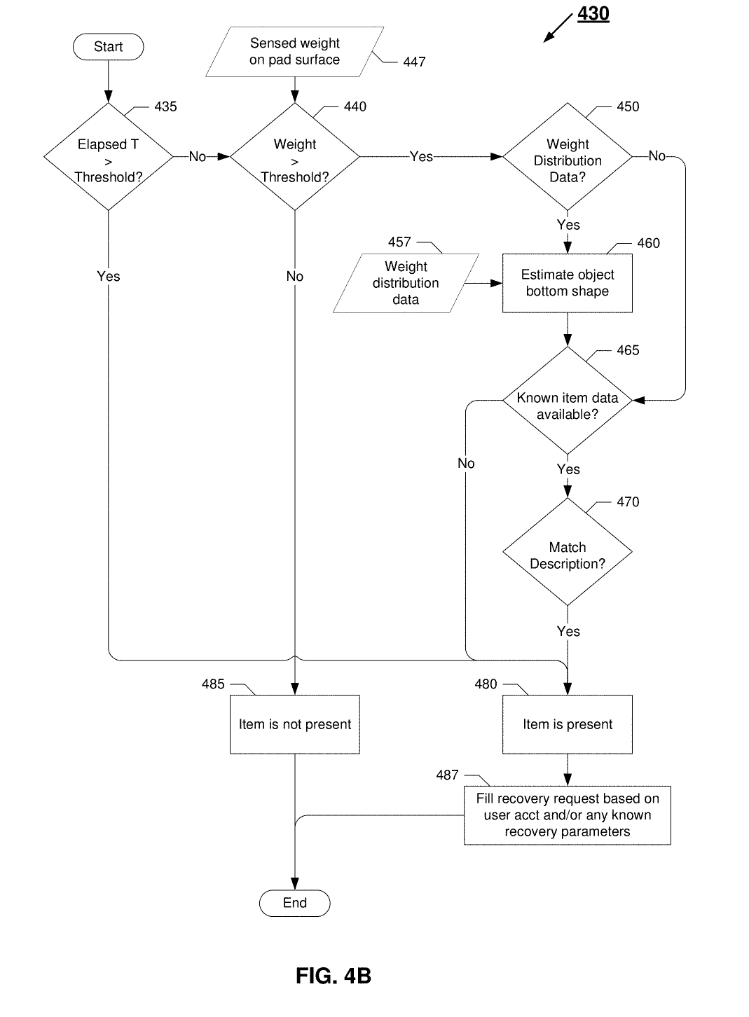

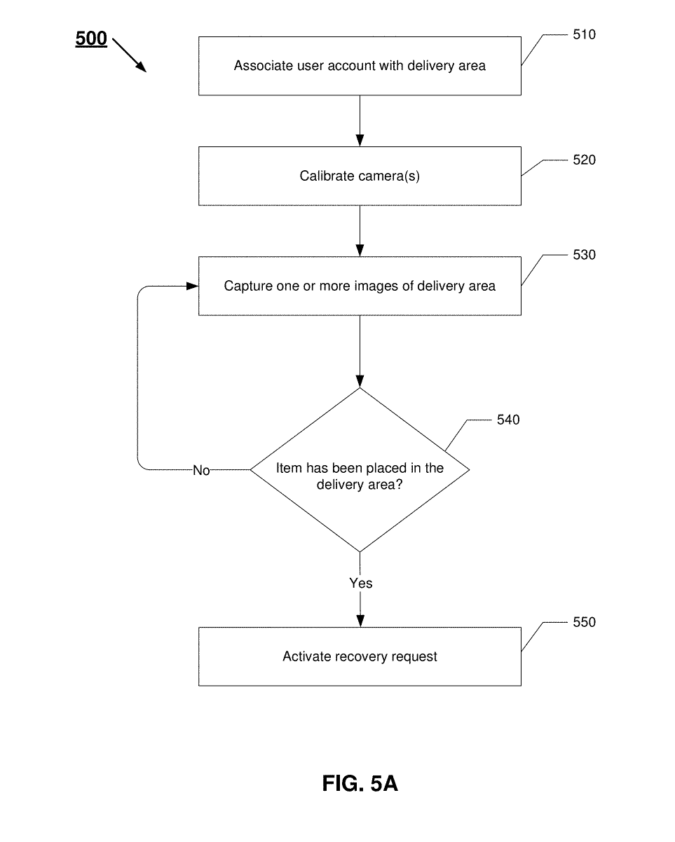

FIG. 4A is a flowchart for an example method 400 of item 102 recovery using a delivery pad 104. The method 400 generally applies to the system 200 depicted in FIG. 2A. A user account 112 may be associated 410 with the delivery pad 104. In various embodiments, the association 410 is performed during a configuration phase using an application 252 executing on a user device 250 where the user account 112 data may be stored on the user device 250 or fetched from a remote server 118. In embodiments, any of the delivery pad 104, application 252, and the remote server 118 may associate the user account 112 with the delivery pad 104. Depending upon the configuration, the association 410 may be performed as a one-time process, when the recovery system 200 is initially used by a user, with new associations 410 subsequently performed with other user accounts when a different user may use the recovery system 200 or when multiple user accounts are maintained by a single user. The association 410 may also be performed anew at each use of the system 200 (e.g., at every instance an item 102 is to be returned).

A weight on the delivery pad surface 106 may be sensed 420. In an embodiment, the delivery pad 104 may exit an idle mode when the weight is sensed 420. In another embodiment, the application 252 may be used to manually trigger the delivery pad 104 to begin sensing for a weight on the delivery pad surface 106. Once the weight is sensed and/or the delivery pad 104 is manually triggered, the weight sensing may continue at a predetermined sampling rate, enabling the processor 130 to monitor an amount of time the weight is sensed and when the weight is removed from the delivery pad surface 106. A confirmation 430 is performed as to whether the sensed weight is an item 102 that has been placed for retrieval as a return item. (See also FIG. 4B.) If the confirmation 430 is negative, the method may return, in an example, to an idle state until sensing a weight 420 again on the delivery pad surface 106 or manually triggered using the application 252. If the confirmation 430 is positive, a recovery request is activated 440. In various embodiments, activating 440 a recovery request may include generating the recovery request and communicating it to a remote server 118, or to an application 252 executing on a user device 250. In an embodiment, the recovery request may be activated in response to a request using an application 252. In an embodiment, the recovery request may be sent directly to an RV 120. As set forth above, the recovery request may include user account data, transaction information, and recovery parameters.

FIG. 4B is a flowchart for an example method 430 of sensing a placement of an object on a delivery pad surface 106 and confirming it as an item 102 for retrieval and return by an RV 120. It will be appreciated that embodiments contemplate that the logical sequences of some actions depicted in FIG. 4B may be ordered differently. In an embodiment, an elapsed time may be measured, using a timer 242 for example, from the time the weight is initially sensed on the delivery pad surface 106. In this case, the sensed weight measurement may be associated with a time stamp reflecting a time of the initial measurement. An estimated elapsed time T since first sensing a weight may then be computed and compared 435 to an upper time threshold. The upper time threshold may represent some maximum elapsed time since first sensing a potential placement of an object on the delivery pad surface 106, after which it may be assumed that the object is an item 102 that should be retrieved and returned. In an embodiment, the object may be a delivered item (e.g., delivered by an RV 120) that has been present continuously until the threshold is reached. It may be assumed that the delivered item should be retrieved to avoid leaving it further on the delivery pad 104 where it may be misappropriated or overly exposed to ambient conditions, for example. In another embodiment, if T is greater than the time threshold, it may be assumed simply that an object on the delivery pad 104 is intended for retrieval and return. In either case, it may then be assumed 480 that an item 102 is present on the delivery pad 104. In an embodiment, if the elapsed time T is less than a lower time threshold, it may be assumed that a spurious weight measurement was caused by some transient event on or near the delivery pad surface 106, and if the weight is no longer sensed then the system can return to its idle state.

If T is not greater than the upper time threshold, a sensed weight 447 on the delivery pad surface 106 may be compared 440 to a weight threshold to determine whether there is an object detectably present on the delivery pad surface 106. In some embodiments, a weight may be sensed on the delivery pad surface 106 by a weight sensor 108. In other implementations, a system of weight sensor nodes 268 may be used to sense weight on the delivery pad surface 106 (see FIG. 2C) which may measure the sensed weight as a sum of some or all of the individual weights sensed at the M×N weight sensor nodes 268. If the sensed weight is not greater than the weight threshold, then the sensed weight may be inferred to have been from a spurious measurement, or that whatever load on the delivery pad surface 106 may be irrelevant regarding item retrieval. In this way, an event such as some object, animal, or person transiently contacting the delivery pad surface 106 may be recognized. It may then be assumed 485 that there is no item 102 for retrieval on the delivery pad 104. On the other hand, if the sensed weight is greater than the weight threshold, then it may be inferred that an item 102 for return retrieval may have been placed on the delivery pad surface 106.

In an embodiment, a sensed weight as measured by a system of weight sensor nodes 268 as shown in FIG. 2C may produce weight distribution data adhering in form to the matrix layout of weight sensor nodes 268(1,1) through 268(M,N). If weight distribution data 457 are available 450, then it may be possible to estimate 460 a bottom shape of the object on the delivery pad surface 106. Thus, given the distances between and geometry of the various nodes, known methods may be applied to the weight distribution data 457 to estimate a shape of a contact area between the object and the delivery pad surface 106. The estimated shape may then inform a further estimate of one or more physical dimensions of the object. In an example, a box-shaped object (e.g., a deliver box) placed on one of its rectangular sides on the delivery pad surface 106 may trigger certain of the weight sensor nodes 268. At one extreme, if the rectangular bottom is fully contained within the boundaries of the delivery pad surface 106, then a length and width of the bottom may be estimated using the spacings within the grid of weight sensor nodes 268. At another extreme, if the rectangular side fully exceeds the boundary of the delivery pad surface 106 and all of the M×N weight sensor nodes 268 are triggered, then no shape information may be derived.

The availability of known item data may be determined 465. In various embodiments, known item data may include (a) information manually input using the application 252, including approximate dimensions of an item 102 (e.g., height, width, depth), (b) information from a user account 112, such as from a history of previous item purchases and/or deliveries maintained for example at the delivery pad 104 (e.g., in memory 234 associated with a processing module 130) including weights and/or dimensions of previously purchased items, and (c) information received from a remote server 118, including with a return authorization for a previously delivered item. If it is determined 465 that no known item data are available, then it may still be assumed 480 that an item 102 is present for retrieval on the delivery pad 104.

Weights and any dimensions estimated 460 from the weight distribution data 457 may be matched 470 in a comparison with dimensions included in known item data described above. If a reasonable match 470 is made, the object may be assumed 480 to be an item 102 present for retrieval.

Once an assumption 480 is established that an item 102 is present in the delivery area 146 for retrieval, a recovery request may be automatically filled 487 based on information from any of the user account 112, information manually input using the application 252, information estimated 460 from weight distribution data 457, and any known item data.

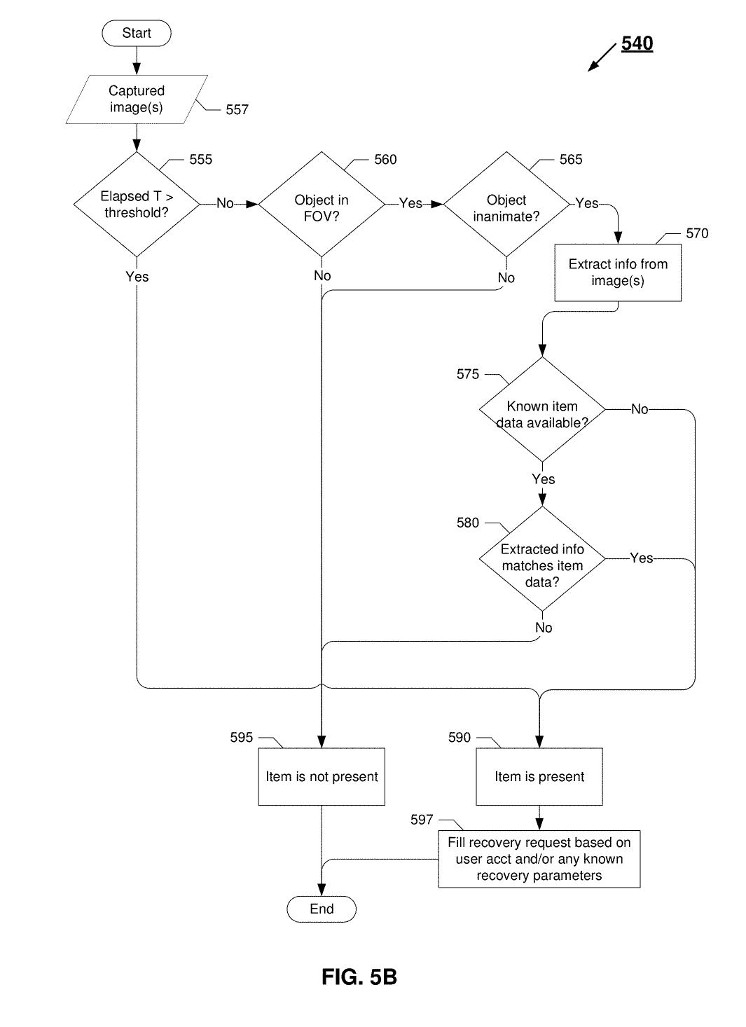

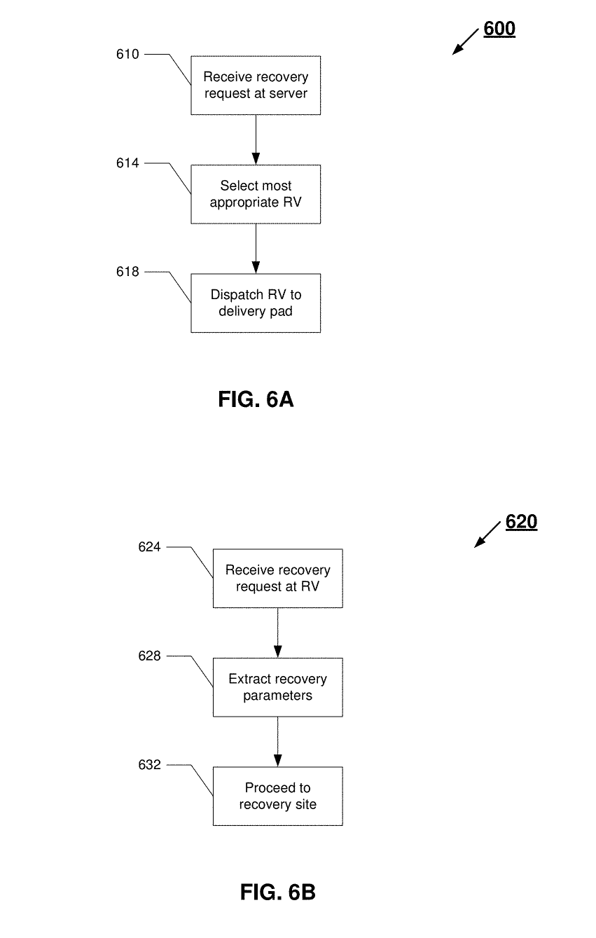

FIG. 5A is a flowchart for an example method 500 of item recovery by an RV 120 using a camera 150. It will be understood that embodiments of camera-based methods and systems disclosed herein contemplate the use of one or more cameras capable of multiple image capture and/or video capture in variable lighting conditions. The method 500 generally applies to the system 300 depicted in FIG. 3. A user account 112 may be associated 510 with the delivery area 146. In various embodiments, the association 510 is performed during a configuration phase using an application 252 executing on a user device 250 or using an interface on a camera 150. User account 112 data may be maintained at the user device 250, at a camera 150, or at a remote server 118. In embodiments, any of the camera 150, application 252, and the remote server 118 may associate the user account 112 with the delivery area 146. Depending upon the configuration, the association 510 may be performed as a one-time process, when the system 300 is initially used by a user, with a new association 510 subsequently performed with another user account when a different user may use the system 300 or when multiple user accounts are maintained by a single user. The association 510 may also be performed anew at each use of the system 300 by any user (e.g., at every instance an item 102 is to be returned).

The camera 150 as shown in FIG. 3 may be calibrated 520. In an embodiment, a calibration 520 is performed as part of an initial configuration of the delivery area 146. A standardized calibrating object with known dimensions may be placed at a specified orientation and position in the delivery area 146. The camera(s) 150 may then be triggered to capture images of the calibrating object, followed by application of known machine vision techniques to calibrate the FOV of the camera(s). Image capture may triggered, for example, by detection of motions related to placing the calibrating object in the FOV. In this case, the camera 150 may be in an idle during which it is continually sampling at a low rate. In another example, after placing the calibrating object in the FOV a user may trigger the camera(s) 150 with the application 252. In some embodiments, the calibrating object may include labels and/or markings providing calibration information such as the calibrating object's dimensions, which may improve detection of the calibrating object's orientation in the captured images. Such labeling may include, but not be limited to, various patterns identifying sides and/or edges of the object, lettering and/or numbering, color coding, and bar and QR® codes, for example. Where multiple cameras 150 are used, images of the various views of the calibrating object may be registered using machine vision techniques, with calibrations for the cameras 150 thereby performed on the combined imagery. In other embodiments, an object of the user's choice may be used as a calibrating object, where the user provides additional information such as the object's dimensions and distances describing the position of the object within the FOV of the camera(s). Such information may be input by the user with the application 252, or with an interface on a camera 150. The application 252 may also be configured to guide the user with instructions regarding the placement of a calibrating object in the FOV. In an example, the calibrating object may be the item 102 to be returned.

In an embodiment, under a steady state operation after calibration 520, one or more images may be captured 530 of the delivery area 146. Such a steady state operation may be an idle mode in which images are captured at a low sampling rate, whereas in an active state the camera(s) 150 operate at a higher sampling rate. Image capture 530 may be triggered by a placement of an object in the FOV of the camera(s) 150, e.g., by motion detection in images captured by the camera(s) 150 or by use of a motion sensor 116. In an embodiment, the application 252 may be used by a user to manually trigger image capture 530. Once the image capture 530 is triggered, it may continue at a predetermined sampling rate, enabling the processor 130 to monitor an elapsed time since the camera 150 was triggered and/or when an object (or item 102) may be removed from the delivery area 146.

Using the images captured 530, a determination is made 540 as to whether the object in the FOV is an item 102 for return and has been properly placed in the delivery area 146. If the determination 540 is negative, the system may return to a previous idle (steady) state awaiting a triggering of image capture 530 as described. In an embodiment, the system 300 may instead be shut down. If the determination 540 is positive, a recovery request is activated 550. In various embodiments, activating 540 a recovery request may include generating the recovery request and communicating it to a remote server 118, or to the application 252 executing on a user device 250. In another embodiment, the recovery request may be sent directly to an RV 120. As previously set forth, the recovery request may include user account data, transaction information, and recovery parameters.

FIG. 5B is a flowchart for an example method 540 of determining whether an item 102 for return has been placed in a delivery area 146. It will be appreciated that embodiments contemplate that the logical sequences of some actions depicted in FIG. 5B may be ordered differently. It is also contemplated that the various actions depicted may be performed at the one or more cameras 150, at one or more control modules 130, or a remote server 118, or distributed amongst any of the foregoing, and that any associated communications between components that may not be explicitly depicted will be recognized by those skilled in the art. In an embodiment, the captured image(s) 557 may include, or have stored with, a time stamp reflecting a time at which the image capture first occurred. An estimated elapsed time T since capture of the image(s) may then be computed and compared 555 to an upper time threshold value. The upper time threshold may represent some maximum elapsed time since first sensing a potential placement of an object in the delivery area 146), after which it may be assumed that the object is an item 102 that should be retrieved and returned. In an embodiment, the object may be a delivered item (e.g., delivered by an RV 120) that has been present continuously until the threshold is reached. It may be assumed that the delivered item should be retrieved to avoid leaving it further in the delivery area 146 where it may be misappropriated or overly exposed to ambient conditions, for example. In another embodiment, if T is greater than the time threshold, it may be assumed simply that an object in the delivery area 146 is intended for retrieval and return. In either case, it may then be assumed 590 that an item 102 is present in the delivery area 146. In an embodiment, if the elapsed time T is less than a lower time threshold, it may be assumed that a spurious triggering event was caused by some transient presence in the FOV 310, and if the presence is no longer sensed then the system may return to its idle state.

If T is not greater than the upper time threshold, a captured image 557 may be analyzed using known machine vision techniques to determine whether there is an object detectably present in the FOV 310. If it is determined 560 that there is no object in the FOV 310, then it may be assumed 595 that there is no item 102 in the delivery area 146. If on the other hand the determination 560 is that there is an object in the FOV 310, then further analysis employing known machine vision techniques may be invoked to determine 565 whether the object is animate. In this way, a transient event such as the movement of a person or animal or some other transitioning object may be accommodated. It will be appreciated that some sources of movement, such as wind-blown foliage, etc., in or outside of a designated delivery area 146 but within the FOV 310, may be accounted for and not substantially affect the accuracy of the determination 565. If it is determined 565 that the object is not inanimate (i.e., the object is moving), then it may be assumed 595 that the object is not an item 102 in the delivery area 146 for retrieval.

If it is determined 565 that the object is inanimate, then information may be extracted 570 from the image(s) 557 using known machine vision techniques. In an embodiment, dimensions (e.g., length, width, height) of the object in the FOV may be estimated against data established during calibration 520. Labeling information (e.g., from labels and/or any visual markings on the surface of the object) may also be extracted 570, including from various patterns identifying sides and/or edges of the object, lettering, numbering, color coding, serial numbers, serial bars, barcodes, and QR® codes, to name some examples. It will be appreciated that various other information may be extracted 570 as well from the captured image(s) 557.

The availability of known item data may be determined 575. In various embodiments, known item data may include (a) information manually input using the application 252, including approximate dimensions of an item 102 (e.g., height, width, depth), (b) information from a user account 112, such as from a history of previous item purchases and/or deliveries maintained for example on a camera 150 (e.g., in memory 234 associated with a processing module 130) including weights and/or dimensions of previously purchased items, and (c) information received from a remote server 118, including with a return authorization for a previously delivered item. If it is determined 575 that no known item data are available, then at this point it may still be assumed 590 that an item 102 is present for retrieval in the delivery area 146.

The information that was extracted 570 from the image(s) may be matched 580 in a comparison with corresponding known item data. In an embodiment, information derived from labeling and/or markings extracted 570 from the image(s) may be read and/or decoded and compared to known item data. Estimated dimensions of the object that were derived from information extracted 570 from the image(s) may be compared to known dimensions of a previously delivered item. If a reasonable match 580 is made between extracted information and known item data, the object may be assumed 590 to be an item 102 present for retrieval.

Once an assumption 590 is established that an item 102 is present in the delivery area 146 for retrieval, a recovery request may be automatically filled 597 based on information from any of the user account 112, information manually input using the application 252, information extracted 570 from the image(s), and any known item data.

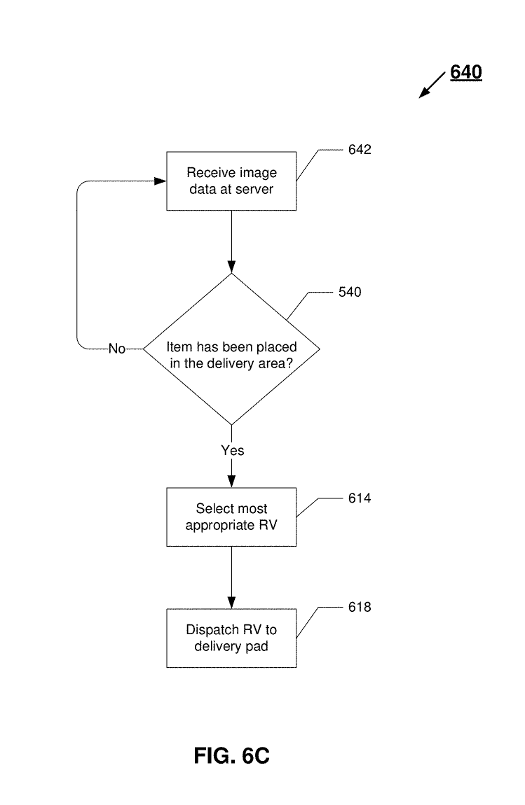

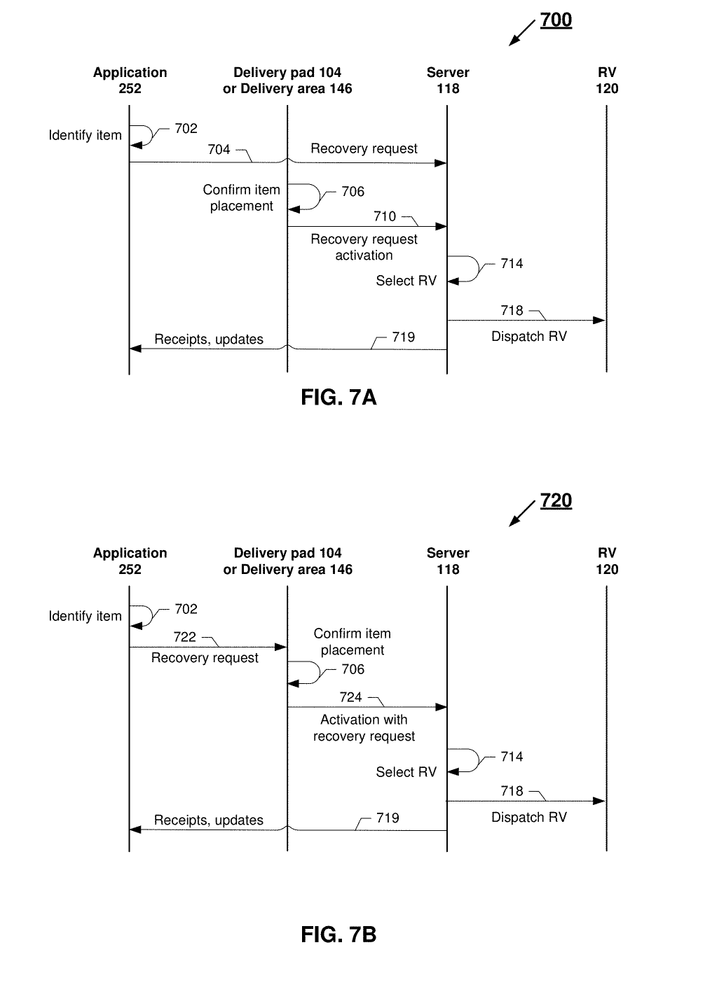

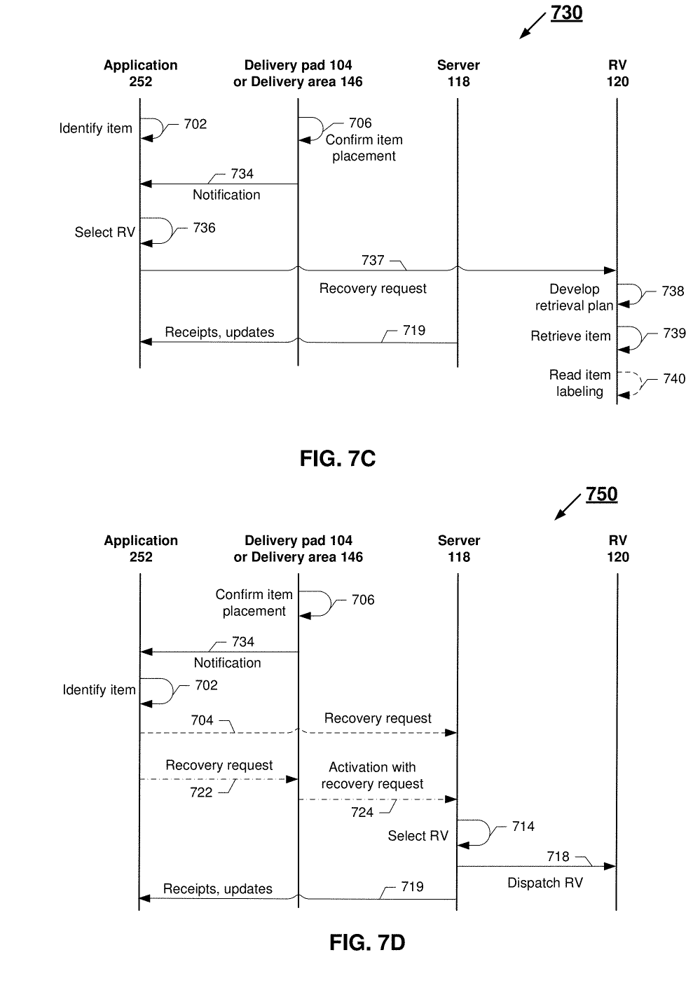

FIG. 6A is a flowchart for an example method 600 of processing a recovery request at a remote server 118. A recovery request including various recovery parameters is received 610 at the remote server by automatic generation at a delivery pad 104 or manual use of an application 252 executing on a user device 250. A most appropriate RV 120 is selected 614 for dispatch to the delivery pad 104. It will be understood that many factors may inform the determination as to which RV 120 to select. The selection may weigh descriptive information in the recovery parameters (described in detail above), such as any of several physical attributes of the item 102, against performance capabilities of RVs 120 available to dispatch for retrieval of the item 102. Additional factors informing the selection may include the proximity of any RV 120 to the delivery pad 104, its remaining range, and routing factors. When an appropriate RV 120 is selected 614 to retrieve the item 102, the selected RV 120 is dispatched 618 to retrieve the item 102. The RV 120 may then navigate to the location of the delivery pad 104 aided by any of, but not limited to, on-board navigation, GPS guidance, and a navigation beacon 238 at the delivery pad 104. Embodiments contemplate controlling the RV 120 using resources of any or all, alone, partially, or in any combination, a camera 150, processing module 130, user device 250, processor 256, application 252, remote server 118, and RV 120, with routing based on information in the user account 112.

FIG. 6B is a flowchart for an example method 620 of processing a recovery request at an RV 120. In an embodiment, a recovery request may be sent directly by automatic generation from a delivery pad 104, delivery area 146, or by manual use of an application 252 executing on a user device 250. Recovery parameters relevant to the retrieval are extracted 628 from the recovery request and other included information and applied to travel planning. The RV 120 proceeds 632 to the delivery pad 104. Embodiments contemplate controlling the RV 120 using resources of any or all, alone, partially, or in any combination, a camera 150, processing module 130, user device 250, processor 256, application 252, remote server 118, and RV 120, with routing based on information in the user account 112.

FIG. 6C is a flowchart for an example method 640 of processing at a remote server 118 image data captured at a delivery area 146. Data including captured images are received 642 at the remote server 118, the data originating from one or more cameras 150 and/or a user device 250 executing an application 252 that is in turn communicatively coupled with the camera(s) 150. In an embodiment, the received image data may have attached user account data and/or recovery parameters. Using the captured images received 642, a determination is made 540 as to whether an object in the FOV of the camera(s) 150 at the delivery area 146 is an item 102 for return, and whether it has been properly placed for retrieval. (See also FIG. 5B.) If the determination 540 is negative, the system 300 at the delivery area 146 may be returned remotely to a previous idle state awaiting a triggering of image capture 530 as described. In an embodiment, the system 300 may instead be shut down remotely. If the determination 540 is positive, a most appropriate RV 120 is selected 614 for dispatch to the delivery area 146. (See also FIG. 6A). When an appropriate RV 120 is selected 614 to retrieve the item 102, the selected RV 120 is dispatched 618 to recover the item 102. The RV 120 may then navigate to the location of the delivery area 146 aided by any of, but not limited to, on-board navigation, GPS guidance, and a navigation beacon 238 located at the delivery area 146. Embodiments contemplate controlling the RV 120 using resources of any or all, alone, partially, or in any combination, a camera 150, processing module 130, user device 250, processor 256, application 252, remote server 118, and RV 120, with routing based on information in the user account 112.

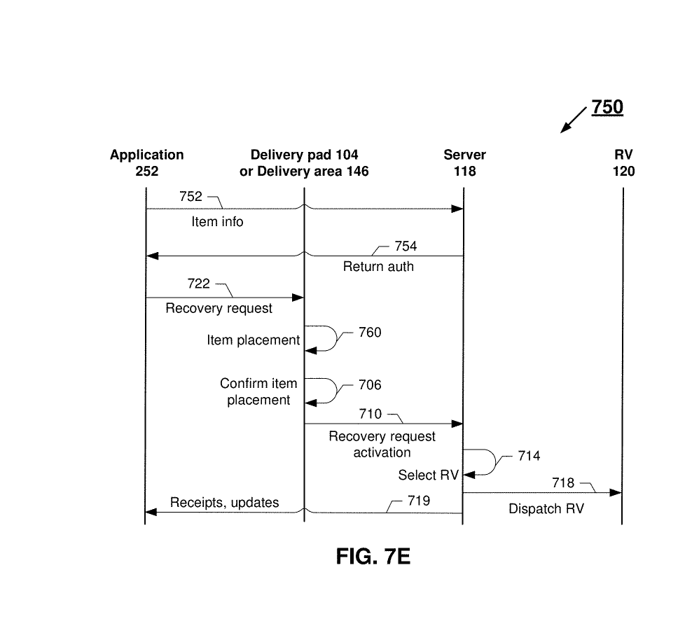

FIGS. 7A-E are flow diagrams for example methods of directing manual and semi-automatic item recovery using an application 252 executing on a user device 250 communicatively coupled variously with a delivery pad 104 or device (e.g., camera 150) in a delivery area 146, a remote server 118, and an RV 120. It will be understood that the series of examples set forth in FIGS. 7A-D represent a few of many possible sequences of interaction between the described components and is not intended to comprise a comprehensive list of possibilities. Further, it will be appreciated that many of the various actions depicted in the flow diagrams of FIGS. 7A-D may be performed in different sequences than shown without departing from embodiments contemplated herein.

In the example method 700 shown in FIG. 7A, an application 252 executing on a user device 250 may be communicatively coupled to a delivery pad 104 or delivery area 146 (e.g., camera 150) and a remote server 118, where the remote server 118 may be communicatively coupled to one or more RVs 120. For ease of disclosure, the term “delivery area 146” will be understood herein as including a device such as, for example, a camera 150. A user (e.g., customer) may use the application 252 to identify 702 the item 102. Identifying 702 may include associating the item 102 with a stored sales invoice and/or user account 112, a history of previously delivered items from which the item 102 may be identified and selecting a like item from a general list of goods available for purchase from the returnee (e.g., vendor from which the item 102 was originally purchased). Identifying 702 may also include manual entry by the user of information including, but not limited to, a return destination address, approximate dimensions of the item 102 for return (e.g., height, width, depth), and a description of the contents of the containing package. The application 252 may estimate a transportation cost based on the input information and a distance to the return destination and, in some embodiments, generate an electronic shipping label associated with the return item 102. Identifying 702 may be performed solely by the application 252 or in conjunction with a remote server 118, in which case it will be understood that various back-end communications between the user device 250 and the server 118 may occur. A recovery request including user account information and recovery parameters, and any information manually entered, may be generated and sent 704 to the remote server 118. An object located on the delivery pad surface 106 or in the delivery area 146 may then be confirmed 706 as an item 102 for return, and an activation sent 710 from the delivery pad 104 or delivery area 146 (e.g., by a camera 150) to the remote server 118 to actuate the recovery request previously sent 704. An appropriate RV 120 may be selected 714 according to methods disclosed herein, which may include development of a retrieval plan for the RV 120, and the selected RV 120 is dispatched 718 to recover the item 102. Receipts, updates, notifications (e.g., retrieval milestones) may be sent 719 at various times for disposition at the application 252. In an embodiment, the notifications may be relayed by the application 252 for presentation on a display 114 at a delivery pad 104 or to the delivery area 146 for presentation on an interface 155 at a camera 150. Embodiments contemplate controlling the RV 120 using resources of any or all, alone, partially, or in combination, a delivery pad 104, a camera 150, processing module 130, user device 250, processor 256, application 252, remote server 118, and RV 120, with routing based on information in the user account 112.

In the example method 720 shown in FIG. 7B, an application 252 executes on a user device 250 that may be communicatively coupled to a delivery pad 104 or delivery area 146 and a remote server 118, where the remote server 118 may be communicatively coupled to one or more RVs 120. A user (e.g., customer) may use the application 252 to identify 702 the item 102, as described above. A recovery request including user account information and recovery parameters, and any information manually entered, may be generated and sent 722 to the delivery pad 104 or delivery area 146. An object located on the delivery pad surface 106 or in the delivery area 146 may then be confirmed 706 as an item 102 for return, and an activation including a recovery request may be sent 724 from the delivery pad 104 or delivery area 146 to the remote server 118. As described above, an appropriate RV 120 may be selected 714 according to methods disclosed herein, which may include development of a retrieval plan for the RV 120, and the selected RV 120 may be dispatched 718 to recover the item 102. Receipts, updates, notifications (e.g., retrieval milestones) may be sent 719 at various times for disposition at the application 252. In an embodiment, the notifications may be relayed by the application 252 for presentation on a display 114 at a delivery pad 104 or to the delivery area 146 for presentation on an interface 155 at a camera 150. Embodiments contemplate controlling the RV 120 using resources of any or all, alone, partially, or in combination, a delivery pad 104, a camera 150, processing module 130, user device 250, processor 256, application 252, remote server 118, and RV 120, with routing based on information in the user account 112.

In the example method 730 shown in FIG. 7C, an application 252 executes on a user device 250 that may be communicatively coupled to a delivery pad 104 or delivery area 146, an RV 120, and remote server 118, where the remote server 118 is communicatively coupled to one or more RVs 120. A user (e.g., customer) may use the application 252 to identify 702 the item 102, as described above. In an embodiment, the user may also generate labeling reflecting various recovery parameters including an address for the return destination, which the user may attach to the item 102 to be returned. An object located on the delivery pad surface 106 or in the delivery area 146 may be confirmed 706 as an item 102 for return. A notification indicating that a placement of an item 102 for return has been confirmed may be sent 734 to the application 252. An appropriate RV 120 may be selected 736 at the application 252 according to methods disclosed herein (in relation to the server 118). A recovery request including user account information and recovery parameters, and any information manually entered, may be generated and sent 737 directly to the selected RV 120. In an embodiment, the recovery parameters may include only, or substantially only, a retrieval location, i.e., the location of the delivery pad 104 or delivery area 146. Upon receiving the recovery request, the selected RV 120 may develop 738 a retrieval plan based upon the recovery request, recovery parameters, and any manually entered information included by the recovery request. The selected RV 120 may then engage the retrieval plan to retrieve 739 the item 102. In an embodiment, e.g., when recovery parameters comprise substantially only a retrieval location, upon arrival at the location of the delivery pad 104 or delivery area 146, the RV 120 may read 740 labeling including, but not limited to, various patterns identifying sides and/or edges of the object, lettering and/or numbering, color coding, bar and QR® codes, or any other coding, on the item 102 to obtain information to complete, complement, and/or confirm the recovery parameters. Receipts, updates, notifications may be sent 719 at various times from the server 118 for disposition at the application 252. In an embodiment, the notifications may be relayed by the application 252 for presentation on a display 114 at a delivery pad 104 or to the delivery area 146 for presentation on an interface 155 at a camera 150. Embodiments contemplate controlling the RV 120 using resources of any or all, alone, partially, or in combination, a delivery pad 104, a camera 150, processing module 130, user device 250, processor 256, application 252, remote server 118, and RV 120, with routing based on information in the user account 112.

In the example method 750 shown in FIG. 7D, an application 252 executes on a user device 250 that may be communicatively coupled to a delivery pad 104 or delivery area 146 and a remote server 118. In an embodiment, the delivery pad 104 or delivery area 146 may be communicatively coupled to the server 118, where the remote server 118 is communicatively coupled to one or more RVs 120. An object located on the delivery pad surface 106 or in the delivery area 146 may be confirmed 706 as an item 102 for return. A notification indicating that a placement of an item 102 for return has been confirmed may be sent 734 to the application 252. The application 252 may then identify 702 the item 102 according to methods described herein. In an embodiment, a recovery request including user account information and recovery parameters, and any information manually entered, may be generated and sent 704 from the application 252 to the remote server 118. In another embodiment, the recovery request may instead be sent 722 from the application 252 to the delivery pad 104 or delivery area 146, which in turn sends 724 an activation including the recovery request to the remove server 118. As described above, an appropriate RV 120 may be selected 714 according to methods disclosed herein, which may include development of a retrieval plan for the RV 120, and the selected RV 120 may be dispatched 718 to recover the item 102. Receipts, updates, notifications (e.g., retrieval milestones) may be sent 719 at various times for disposition at the application 252. In an embodiment, the notifications may be relayed by the application 252 for presentation on a display 114 at a delivery pad 104 or to the delivery area 146 for presentation on an interface 155 at a camera 150. Embodiments contemplate controlling the RV 120 using resources of any or all, alone, partially, or in combination, a delivery pad 104, a camera 150, processing module 130, user device 250, processor 256, application 252, remote server 118, and RV 120, with routing based on information in the user account 112.

In the example method 770 shown in FIG. 7E, the application 252 is communicatively coupled to a delivery pad 104 or delivery area 146, and with a remote server 118, where the remote server 118 is communicatively coupled to one or more RVs 120. The delivery pad 104 or delivery area 146 may be communicatively coupled to the server 118 as well. An identifier of an item 102 is sent 752 to the remote server 118. The remote server may then respond by sending 754 a return authorization (“RA”) to the application 252. The application may generate a recovery request including user account information and recovery parameters and send 722 the recovery request to the delivery pad 104 or the delivery area 146. An object (i.e., a return item 102) may be placed 760 on the delivery pad surface 106 or in the delivery area 146. The object may then be confirmed 706 as the item 102 for return. An activation including the recovery request may then be sent 710 from the delivery pad 104 or delivery area 146 to the remove server 118. As described above, an appropriate RV 120 may be selected 714 according to methods disclosed herein, which may include development of a retrieval plan for the RV 120, and the selected RV 120 may be dispatched 718 to recover the item 102. Receipts, updates, notifications may be sent 719 at various times for disposition at the application 252. In an embodiment, the notifications may be relayed by the application 252 for presentation on a display 114 at a delivery pad 104 or to the delivery area 146 for presentation on an interface 155 at a camera 150. Embodiments contemplate controlling the RV 120 using resources of any or all, alone, partially, or in combination, a delivery pad 104, a camera 150, processing module 130, user device 250, processor 256, application 252, remote server 118, and RV 120, with routing based on information in the user account 112.

Various forms of computing devices may be implemented in the disclosed embodiments for recovering an item 102 described with reference to FIGS. 1-8, including personal computers, mobile computing devices (e.g., smartphones, etc.), servers, laptop computers, etc. Such computing devices may typically include, at least, the components presented in FIG. 8, which illustrates an example server device. With reference to FIGS. 1-8, a server 118 may typically include a processor 810 coupled to volatile memory 820 and large capacity nonvolatile memory 830,840, such as a disk drive. The server 118 may also include a floppy disc drive, compact disc (CD) or digital versatile disc (DVD) disc drive coupled to the processor 810. The server 118 may also include network access ports 850 (or interfaces) coupled to the processor 810 for establishing data connections with a network, such as the Internet and/or a local area network coupled to other system computers and servers. Similarly, the server 118 may include additional access ports 860, such as USB, Firewire, Thunderbolt, and the like for coupling to peripherals, external memory, or other devices.

The foregoing method descriptions and the process flow diagrams are provided merely as illustrative examples and are not intended to require or imply that the operations of the various embodiments must be performed in the order presented. As will be appreciated by one of skill in the art, the order of operations in the foregoing embodiments need not be performed in any fixed order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in relation to embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon application and design constraints imposed on the overall system. Skilled artisans may implement the described functionality in varying ways for any of the many applications, but such implementation decisions will be understood as not departing from the scope of the claims.

Hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of recovering an item using a robotic vehicle (RV), comprising:
associating a camera, with a user account, wherein a field of view for the camera corresponds to a delivery area;
capturing, with the camera, one or more images of the delivery area;
determining, based on the one or more images, whether an item has been placed in the delivery area;
activating a recovery request for an RV to recover the item.

2. The method of claim 1, wherein said determining is performed at the camera.

3. The method of claim 1, wherein said determining is performed at a remote server in communication with the camera.

4. The method of claim 1, further comprising:
controlling the RV to travel to the delivery area and obtain the item.

5. The method of claim 4, further comprising:
routing the RV with the obtained item to a location based on information associated with the user account.

6. The method of claim 1, wherein said capturing one or more images of the delivery area is triggered using an application executed on a user device, the application associated with the user account.

7. The method of claim 1, wherein said activating a recovery request is in response to a request using an application.

8. The method of claim 1, wherein said activating a recovery request is in response to determining that an item has been placed in the delivery area.

9. The method of claim 1, further comprising:
determining that the item is the same as a previously delivered item by comparing one or more physical dimensions of the item with one or more physical dimensions of the previously delivered item.

10. The method of claim 1, further comprising:
determining that the item is the same as a previously delivered item by comparing one or more visual markers of the item with one or more visual markers of the previously delivered item.

11. The method of claim 1, further comprising detecting a motion in the delivery area.

12. The method of claim 1, wherein said activating a recovery request includes sending the recovery request to a server configured to dispatch an RV to the delivery area.

13. The method of claim 12, wherein a type of RV is selected at the server based at least on the one or more physical dimensions of the item and the weight of the item.

14. A system for recovery of an item using a robotic vehicle (RV), comprising:
a camera for capturing one or more images of a delivery area, and
configured in part to:
associate a user account with the delivery area,
determine, from the one or more images, whether an item has been placed in the delivery area, and
activate a recovery request for an RV to recover the item; and
a remote server to receive the recovery request and dispatch the RV.

15. The system of claim 14, wherein an application is used to trigger the camera to capture the one or more images.

16. The system of claim 14, wherein said activating the recovery request is in response to a request using the application, the application executed on a user device and associated with the user account.

17. The system of claim 14, wherein said activating a recovery request is in response to determining that an item has been placed in the delivery area.

18. The system of claim 14, wherein the remote server is configured to determine a type of RV to be dispatched based on at least one of a weight of the item, or one or more physical dimensions of the item.

19. The system of claim 14, wherein the control module is further configured to determine that the item placed in the delivery area is the same as a previously delivered item.

20. The system of claim 19, wherein the control module is further configured to compare one or more visual markers of the item with one or more visual markers of the previously delivered item.

21. The system of claim 14, wherein the camera is further configured to detect, using the one or more images, a motion in the delivery area.

22. The system of claim 14, wherein activating a recovery request includes sending the recovery request to the RV.

23. An apparatus for recovery of an item using a robotic vehicle (RV), comprising:
means for associating a user account with a delivery area;
means for capturing one or more images of the delivery area; and
means for determining, from the one or more images, whether an item has been placed in the delivery area;
means for activating a recovery request for an.

24. The apparatus of claim 23, further comprising:
means for controlling the RV to travel to the delivery area and obtain the item.

25. The apparatus of claim 24, further comprising:
means for routing the RV with the obtained item to a location based on information associated with the user account.

26. The apparatus of claim 23, wherein said means for capturing one or more images of the delivery area is triggered using an application executed on a user device, the application associated with the user account.

27. The apparatus of claim 26, wherein said means for activating a recovery request includes means for sending the recovery request in response to a request using the application.

28. The apparatus of claim 23, further comprising:
means for determining that the item is the same as a previously delivered item by comparing one or more physical dimensions of the item with one or more physical dimensions of the previously delivered item.

29. The apparatus of claim 23, further comprising:
means for determining that the item is the same as a previously delivered item by comparing one or more visual markers of the item with one or more visual markers of the previously delivered item.

30. A non-transitory processor-readable storage medium having stored thereon processor-executable instructions configured to cause a processor to perform operations comprising:
associating a user account with a delivery area;
sensing, using one or more captured images of the delivery area, a placement of an item in the delivery area;
activating a recovery request to a robotic vehicle (RV) based at least on information in the user account.
